(19) United States
(12) Patent Application Publication
(10) Pub. No.: US 2002/0113715 A1
(43) Pub. Date: Aug. 22, 2002

(54) System and method for simultaneously verifying conformity of a carry-on luggage to maximum permissible size and weight values

(75) Inventor: Kenneth Wilson, Ville Lasalle (CA)

Correspondence Address: Mr. Daniel Bourque, Esq., BOURQUE & ASSOCIATES, P.A., Suite 303, 835 Hanover Street, Manchester, NH, 03104, US

(73) Assignee: Weigh-Tronix Canada, ULC

(21) Appl. No.: 09/789,085

(22) Filed: Feb. 20, 2001

(51) Int. Cl. G08B 5/22

(52) U.S. Cl. 340/815.45; 340/540

(57) ABSTRACT

The system is used for simultaneously verifying the conformity of carry-on luggage to maximum permissible size and weight values, such as the ones imposed by airline companies. The system comprises a sizing template having a receiving area and an opened side allowing insertion and removal of the carry-on luggage from the receiving area. The receiving area of the sizing template has dimensions delimiting the maximum permissible size values forwhich the carry-on luggage has to conform with. The system further comprises a weight sensor configured and disposed with reference to the sizing template to measure the weight value of the carry-on luggage once it is set in the receiving area thereof. A display unit, responsive of the weight value of the carry-on luggage, allows to indicate whether the carry-on luggage is conform with respect to the maximum permissible weight value or not. This system is particularly useful in airports but could be used with other transportation systems as well.

### BACKGROUND OF THE INVENTION

The present invention relates to a system and a method for simultaneously verifying conformity of carry-on luggage to maximum permissible size and weight values. This invention would be particularly useful in an airport and can also be used in other places, including other transportation systems.

Almost all airline passengers bring at least one carry-on luggage on board of an airplane. These carry-on luggage include any kind of suitcase, briefcase, bag, box or any other baggage. These carry-on luggage are to be stored in flight in overhead storage bins or under the seats. Some carry-on luggage may also be stored in closets near the doors of an airplane. Typically, many passengers travelling on short or medium range routes have no check-in luggage and bring all their gear aboard the airplane in order to save time by not waiting for their luggage at the end of their flight and to avoid damages or loss.

Space aboard an airplane is relatively limited and restricted. As a result, strict rules concerning maximum permissible size values are edicted by the airline companies. Convenient sizing templates have been used in airports for many years to allow passengers to verify if their luggage is within the maximum permissible size values and therefore could be brought on board as carry-on luggage. Any luggage outside one of these maximum values has to be checked in and put in the cargo bay of the airplane.

A maximum weight for carry-on luggage is also imposed in addition to the maximum permissible size values. One of the reasons is that heavy carry-on luggage stored in an overhead bin could overload the door or the bin itself and fall on passengers sitting below, especially if the airplane hits the ground violently or during heavy turbulence. Another reason is that all carry-on luggage may not be properly accounted for in the total mass of the airplane, especially if many people bring on board heavy carry-on luggage. A typical maximum permissible weight value of carry-on luggage is ten kilograms.

Generally, passengers do not know exactly the weight value of their carry-on luggage and do not go to a check-in counter to have the luggage weighed on a scale. The presence of automated registration machines allow passengers to avoid check-in counters and to have the opportunity to verify the weight of their carry-on luggage. Yet, the airline personnel usually does not verify the weight of carry-on luggage unless it is very obvious that the weight is well above the limit. Even then, a scale has to be nearby to weigh the suspected luggage.

### SUMMARY OF THE INVENTION

It has been found that one way to have a passenger verify both the size and the weight of his or her carry-on luggage is to provide the sizing templates with a weight sensor which allows the luggage to be weighed while it is set in the sizing template. The weight value or another indication is then provided to the user as to whether the carry-on luggage is conform with respect to the maximum permissible weight or not. This way, checking conformity of carry-on luggage to maximum permissible size and weight values can be done at the same time.

The present invention will be better understood form the following description and appended figures.

### BRIEF DESCRIPTION OF THE FIGURES

FIG. 1 is a perspective view of a system according to a possible embodiment of the present invention.

FIG. 2 is an enlarged view of the lower end of the sizing template and the weight sensor of the system shown in FIG. 1.

FIG. 3 is a block diagram showing the typical connections between the various components.

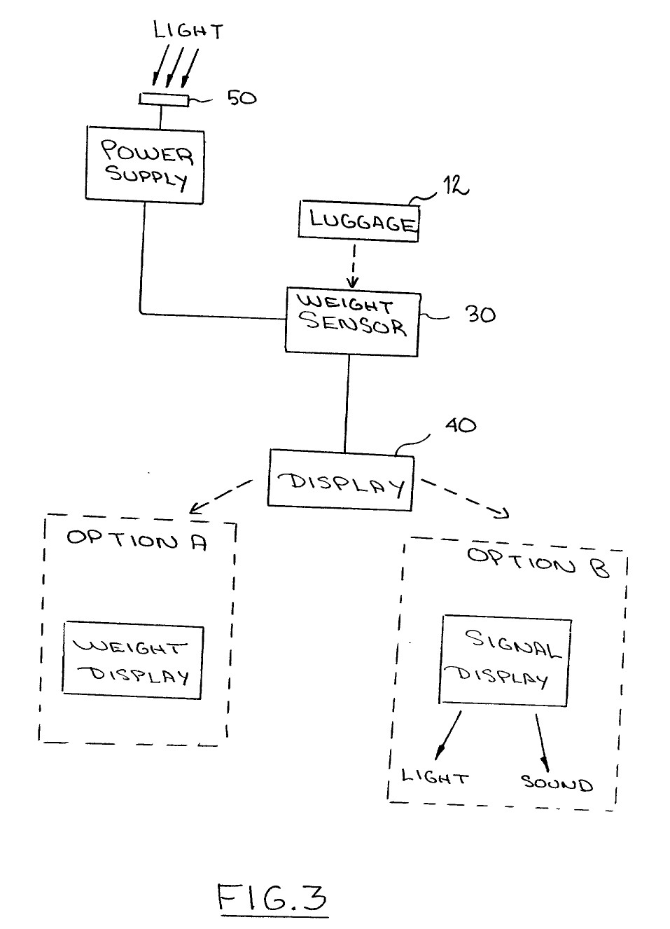

### DETAILED DESCRIPTION

A system (10) according to a possible and preferred embodiment of the present invention is described hereinafter and illustrated in the appended figures. The system (10) comprises a sizing template (20) having at least one receiving area (22) with an opened side (24), usually the upper side, allowing insertion and removal of carry-on luggage (12) from the receiving area (22). The sizing template (20) is usually made of stainless steel tubes (26) forming a cage-like structure. The size of the receiving area (22) is indicative of the maximum permissible size values imposed by the airlinecompany.

Many airline companies allow passengers to bring two carry-on luggage on board. The second one has typically smaller maximum permissible size values and the sizing template (20) preferably has a second receiving area (22′) to accommodate the smaller carry-on luggage. Alternatively, two separate sizing templates (not shown) could be used. Using only one sizing template with two receiving areas is however preferred.

The sizing template (20) is also usually provided with an information panel (28) giving information to the passengers concerning the requirements of carry-on luggage (12). For instance, the requirements may be different depending if a passenger travels in first class, business or economic class. It also identifies to which airline company or companies the sizing template (20) is applicable.

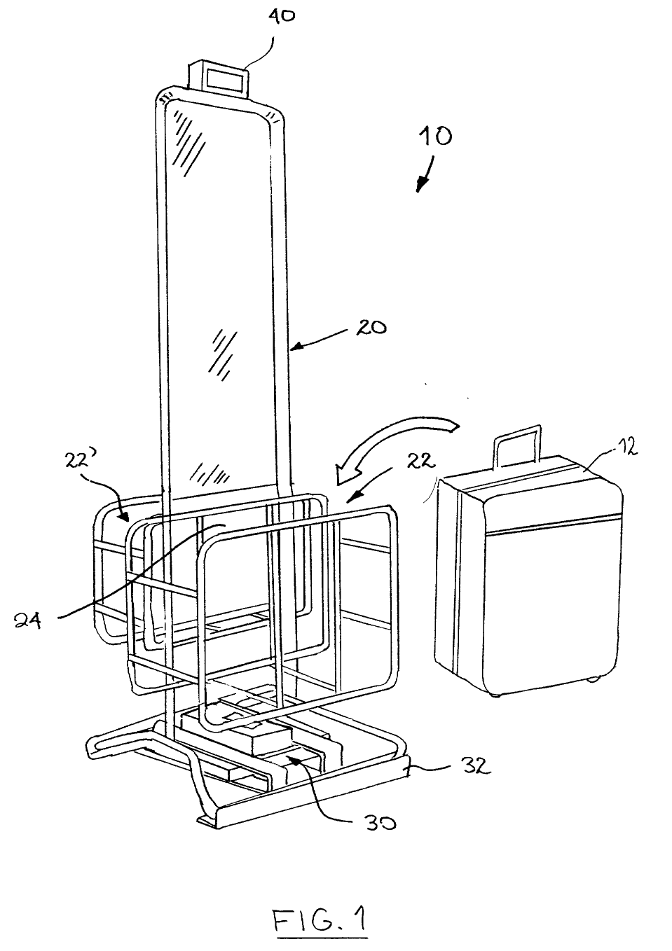

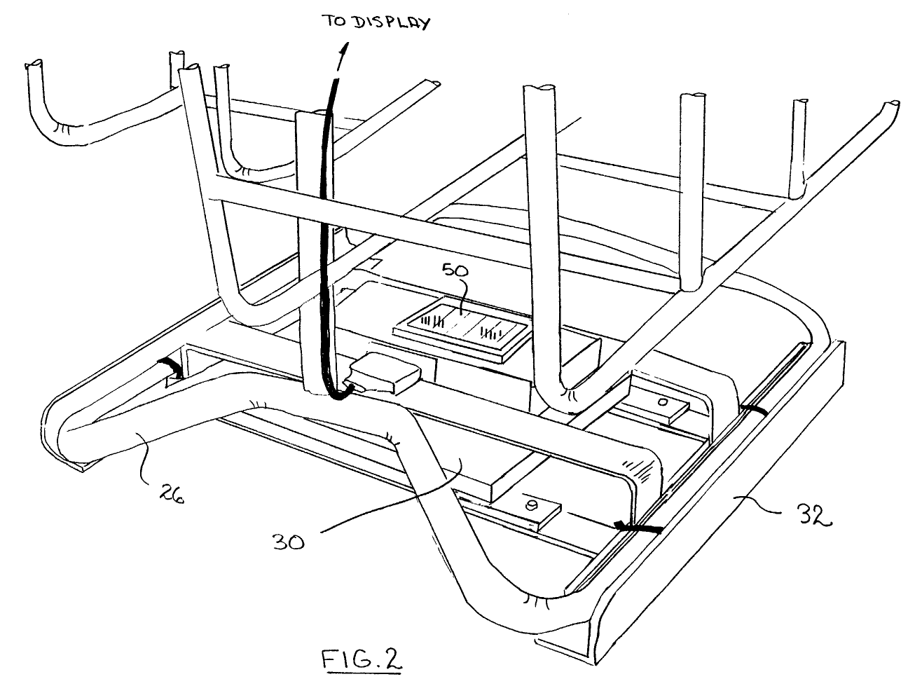

In accordance with the present invention, the system (10) is provided with a weight sensor (30) which is configured and disposed with reference to the sizing template (20) to measure the weight value of the carry-on luggage (12) once it is set in the receiving area (22, 22′) thereof. In the embodiment illustrated in FIGS. 1 and 2, the sizing template (20) is mounted directly over the weight sensor (30). FIG. 2 shows that the lower end of the sizing template (20) rests on a supporting frame (32) of the weight sensor (30). The weight sensor (30) thus also supports the weight of the sizing template (20) and can measure the difference between the combined weight of the sizing template (20) and the carry-on luggage (12) with that of the sizing template (20) alone.

The weight sensor (30) is either a scale-like apparatus, such as the one illustrated in FIGS. 1 and 2, or could be a device using strain gages or similar devices to measure changes in the structure of the sizing template (20) and translate that into weight values following a previous calibration procedure.

The system (10) also comprises a display unit (40) responsive of the weight value of the carry-on luggage (12). The purpose of the display unit (40) is to provide an indication as to whether the carry-on luggage (12) is conform with respect to the maximum permissible weight or not. This display unit (40) can take many forms.

In the preferred and illustrated embodiment, the display unit (40) is an electronic display that indicates the actual value of the carry-on luggage (12). The weight sensor (30) sends a signal to the display unit (40) located at the top of the sizing template (20). The display unit (40) can be installed on any convenient location if required, including a nearby wall or object. By comparing this actual value to the maximum permissible weight value, the passenger is able to determine if the carry-on luggage (12) is conform or not with the requirements. In that case, the maximum permissible weight value should be indicated on the display panel (28) or be otherwise communicated to the passenger.

Another possible embodiment is to have the display unit (40) showing the results of the comparisons between the actual and the maximum permissible weight values stored in an electronic memory or another storage medium. This can take place as either a visual signal or an audible signal. For instance, there can be a red and green light as a visual signal, indicating if the carry-on luggage (12) passed the test (green) or not (red). An audible signal can also be used to signify that the carry-on luggage is above the weight limit. Both visual and audible signals could be used simultaneously if desired. Of course, there is a number of other possible combinations of visual and audible signals that could be used to notify the passenger that the carry-on luggage (12) is conform with respect to the maximum permissible weight or not.

If two or more maximum permissible weight values are to be in the comparison, which could be the case when the same sizing template (20) has two receiving areas (22, 22′), a detector (not shown) can be provided for the system (10) to know which value is to be used from its memory.

When the weight sensor (30) and the display unit (40) involves electronic circuits, these circuits can be powered by a battery or through an AC outlet. However, as shown in FIGS. 1 and 2, the electronic circuits are powered by a photovoltaic panel (50) located on the weight sensor (30). The panel (50) could also be located anywhere else. This allows the system (10) to be self reliable even with minimal lighting from the lights of the airport when there is no sunlight.

Preferably, the system (10) is designed to allow the use of existing sizing templates (20) by receiving them on the supporting frame (32) of the weight sensor (30). The lower end of the sizing template (20) is then fastened to the supporting frame (32) in a suitable manner.

Although electronic weight sensors and display units are preferred, a mechanical system could be used in a similar manner. The weight sensor (30) would then be a mechanized device using any of the known mechanical instruments to measure the weight, such as spring mechanisms, deflection bars, etc. The weight value of the carry-on luggage (12) would be displayed either as the actual weight or any other indication which allows the user to know whether the carry-on luggage (12) is conform with the maximum permissible weight requirements or not.

In use, a passenger inserts the carry-on luggage (12) into one of the receiving areas (22, 22′) of the sizing template (12) to verify its conformity with the maximum permissible size value. Simultaneously, the weight value of the carry-on luggage (12) is measured. Either the passenger or the system (10) then evaluates whether the weight value of the carry-on luggage (12) is equal or below the maximum permissible weight value, therefore in conformity with the weight requirements.

Although a preferred embodiment of the present invention has been described in detail herein and illustrated in the accompanying figures, it is to be understood that the invention is not limited to this precise embodiment and that various changes in the modifications may be effected therein without departing from the scope or spirit of the present invention. Many examples of these possible modifications have been indicated throughout the text of the detailed description. Other modifications are also possible.

For instance, although the sizing template (20) is shown as a cage-like structure, it could be in the form of a housing or have other forms. Also, it would be possible to overhang the system from a wall or ceiling and have the weight sensor (30) at a different place than beneath the sizing template (20).

The present invention may be conveniently used by passengers in a an airport. It should be noted that it could be used in other kinds of transportation systems where the conformity of carry-on luggage with the maximum permissible size and weight values has to be verified. The term “passenger” also includes any possible user, such as the airline personnel assisting passengers.

What is claimed is:

1. A system for simultaneously verifying conformity of a carry-on luggage to maximum permissible size and weight values, the system comprising:
a sizing template comprising a receiving area and an opened side allowing insertion and removal of the carry-on luggage from the receiving area, the receiving area having dimensions delimiting the maximum permissible size values for which the carry-on luggage has to conform with;
a weight sensor configured and disposed with reference to the sizing template to measure the weight value of the carry-on luggage once it is located in the receiving area thereof; and
a display unit responsive of the weight value of the carry-on luggage and indicating whether the carry-on luggage is conformed with respect to the maximum permissible weight value or not.

2. A system according to claim 1, wherein the sizing template comprises a cage-like structure.

3. A system according to claim 2, wherein the sizing template is mounted directly over the weight sensor.

4. A system according to claim 1, wherein the display unit comprises means for displaying the weight value of the carry-on luggage.

5. A system according to claim 1, wherein the display unit comprises means for comparing the weight value of the carry-on luggage with the maximum permissible weight value and emitting a signal indicative whether the carry-on luggage is conformed with respect to the maximum permissible weight value or not.

6. A system according to claim 5, wherein the signal is a visual signal.

7. A system according to claim 5, wherein the signal is an audible signal.

8. A system according to claim 1, further comprising a photovoltaic panel as a power source.

9. A system for simultaneously verifying conformity of a carry-on luggage to maximum permissible size and weight values, the system comprising:
first means for receiving the carry-on luggage and allowing verification of its conformity with the maximum permissible size values;
second means for measuring a weight value of the carry-on luggage once it is set in the first means; and
third means for indicating whetherthe carry-on luggage is conformed with respect to the maximum permissible weight value or not.

10. A system according to claim 9, wherein the first means comprises a cage-like structure having dimensions delimiting the maximum permissible size values for which the carry-on luggage has to conform with.

11. A system according to claim 10, wherein the first means is mounted directly over the second means.

12. A system according to claim 9, wherein the third means comprises means for displaying the weight of the carry-on luggage.

13. A system according to claim 9, wherein the third means comprises means for comparing the weight value of the carry-on luggage with the maximum permissible weight value and emitting a signal indicative whether the carry-on luggage is conformed with respect to the maximum permissible weight value or not.

14. A system according to claim 13, wherein the signal is a visual signal.

15. A system according to claim 13, wherein the signal is an audible signal.

16. A system according to claim 9, further comprising a photovoltaic panel as a power source.

17. A system for allowing a simultaneous conformity verification of a carry-on luggage to maximum permissible size and weight value once it is set in a carryon luggage sizing template, the system comprising:
a supporting frame for receiving and holding a lower end of a carry-on luggage sizing template;
a weight sensor located underneath the supporting frame, the weight sensor being configured and disposed to measure the weight value of the carry-on luggage once it is set in the sizing template; and
a display unit responsive of the weight value of the carry-on luggage and indicating whether the carry-on luggage is conformed with respect to the maximum permissible weight value or not.

18. A system according to claim 17, wherein the display unit comprises means for displaying the weight value of the carry-on luggage.

19. A system according to claim 17, wherein the display unit comprises means for comparing the weight value of the carry-on luggage with the maximum permissible weight value and emitting a signal indicative whether the carry-on luggage is conformed with the maximum permissible weight value or not.

20. A system according to claim 19, wherein the signal is a visual signal.

21. A system according to claim 20, wherein the signal is an audible signal.

22. A system according to claim 17, further comprising a photovoltaic panel as a power source.

23. A method for simultaneously verifying conformity of a carry-on luggage to maximum permissible size and weight values, the method comprising the steps of:
(a) inserting the carry-on luggage in a receiving area of a sizing template to verify its conformity with respect to maximum permissible size values;
(b) measuring the weight value of the carry-on luggage while it is in the sizing template; and
(c) evaluating whether the weight value of the carry-on luggage is conformed with respect to the maximum permissible weight value or not.

24. A method according to claim 23, wherein step (c) comprises informing a user of the maximum permissible weight value and displaying the weight value of the carry-on luggage for comparison.

25. A method according to claim 23, wherein step (c) comprises reading the maximum permissible weight value in a memory, comparing the read value to the weight value of the carry-on luggage, and emitting a signal indicative whetherthe carry-on luggage is conformed with respect to the maximum permissible weight value or not.

26. A method according to claim 25, wherein the sub-step of emitting a signal comprises emitting a visual signal.

27. A method according to claim 25, wherein the sub-step of emitting a signal comprises emitting an audible signal.
